(19) United States
(12) Patent Application Publication
(10) Pub. No.: US 2025/0114965 A1
(43) Pub. Date: Apr. 10, 2025

(54) LOG SPLITTER FOR MOBILE APPLICATIONS

(71) Applicants: Simon Heck, Osterburken (DE); Holger Häberlen, Bad Mergentheim (DE)

(72) Inventors: Simon Heck, Osterburken (DE); Holger Häberlen, Bad Mergentheim (DE)

(21) Appl. No.: 18/905,340

(22) Filed: Oct. 3, 2024

(30) Foreign Application Priority Data
Oct. 4, 2023 (DE) 10 2023 126 904.6

(51) Int. Cl. B27L 7/06

(52) U.S. Cl. CPC B27L 7/06

(57) ABSTRACT

Log splitter for mobile applications, comprising a coupling for connection to a drive, a receiving unit for a piece of wood to be split, at least one splitting wedge arranged perpendicularly to the receiving unit, a stop surface arranged opposite the splitting wedge, a spindle and a thread receptacle, wherein the spindle can be moved along the thread receptacle or the thread receptacle can be moved along the spindle by means of a drive, wherein the coefficient of friction μ between the spindle and the thread receptacle is 0.001 to 0.048.

### CROSS-REFERENCE TO RELATED APPLICATIONS

This patent application claims priority to German utility patent application number 10 2023 126 904.6 filed Oct. 4, 2023, and titled “log splitter for mobile applications”. The subject matter of patent application number 10 2023 126 904.6 is hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The present invention pertains to a log splitter for mobile applications. The invention pertains to the technical field of devices for splitting pieces of trees into logs, mostly intended for use as firewood.

### BACKGROUND

Log splitters, in particular horizontal splitters, are predominantly provided with a hydraulic cylinder through which a splitting ram presses a piece of wood lying on a support against a stationary blade. The piece of wood is thereby split into two or more pieces.

In another embodiment, the splitting wedge is pressed against the material to be split. State-of-the-art log splitters have a two-hand release to prevent accidents, but appropriate protective clothing is still required.

The main performance data of log splitters are the type of drive, the maximum dimensions of the material to be split (length and diameter), the splitting force and the reverse speed.

Most log splitters are equipped with oil-powered hydraulics. They are driven by a tractor using a PTO shaft, an electric motor (230 or 400 V) or an internal combustion engine.

Log splitters commonly used in ordinary households for wood processing are mostly powered by a 230 V or 400 V electric motor.

The splitting force is normally given in tons (t), although the SI system of units uses Newtons (N).

Hydraulic log splitters are available in upright or horizontal designs as well as in the form of combination devices, in which sawing and splitting is possible with one machine. Larger devices have a stroke of over one meter and the table can often be adjusted in height to enable shorter pieces to be split more quickly.

In order to achieve the required splitting force, the energy consumption required for conventional log splitters is high.

Log splitters are known in the prior art from DE 195 43 664 A1, DE 196 40 687 A1, DE 10 2021 112 730 A1 and DE 297 22 633 U1.

### SUMMARY

The present invention is based on the technical problem of providing a log splitter for mobile applications, which can be operated with lower energy consumption and is optimized for mobile applications in terms of its dimensions and weight.

The log splitter according to the invention is defined by the features of independent claim 1. Advantageous aspects form the subject-matter of the respective subclaims.

The invention encompasses a log splitter for mobile applications, comprising a coupling for connection to a drive, a receiving unit for a piece of wood to be split, at least one splitting wedge arranged perpendicularly to the receiving unit, a stop surface arranged opposite the splitting wedge and a spindle as well as a thread receptacle, wherein the spindle can be moved along the thread or the thread receptacle can be moved along the spindle by means of a drive. The coefficient of friction μ between the spindle and the thread receptacle is 0.001 to 0.048. This means that less energy is required to move the thread receptacle along the spindle and to generate the force required for splitting. The coefficient of friction, also known as the amount of friction (formula symbol μ or f), is a quantity of the dimension number for the ratio of the frictional force to the contact pressure between two bodies.

### BRIEF DESCRIPTION OF THE DRAWINGS

The invention is explained in more detail below with reference to a drawing.

In the drawings:

FIG. 1 shows a schematic representation of a log splitter according to the

invention in the form of a horizontal splitter, in which a splitting ram presses a piece of wood lying on a support against a stationary blade;

FIG. 2 shows a schematic representation of a log splitter according to the invention in the form of an upright log splitter, in which the splitting wedge is driven through a piece of wood standing on the stop surface;

FIG. 3 shows a schematic representation of a transportable log splitter according to the invention for placement on the piece of wood to be split; and

FIG. 4 shows a schematic view of a drive unit for the log splitter according to the invention.

### DETAILED DESCRIPTION

One advantageous technical aspect is that the receiving unit is mounted horizontally on at least one rollable support means. This allows the log splitter to be moved along a plane and thus can be easily transported to different locations.

According to a preferred aspect, the log splitter further comprises an energy storage unit (battery) for storing and providing energy for the drive. The energy storage unit is integrated into the drive and can be designed to be exchangeable. This allows the log splitter to operate autonomously, which is advantageous for use in remote forest areas.

It has proven to be advantageous if the drive is integrated into the support means. This protects the drive from dirt, dust and flying pieces of wood, which extends the service life of the log splitter.

Advantageously, the spindle is a planetary roller screw drive or a spindle drive with a friction-optimized polymer nut. This results in particularly low friction losses and the log splitter can be operated with a very low energy input.

In an alternative embodiment, the spindle is a ball screw, whereby the coefficient of friction μ between the ball screw and the thread receptacle is 0.001 to 0.018, resulting in particularly low friction losses. In the ball screw, both the spindle and the thread receptacle have a helical groove in which a ball runs. The transmission ratio can be adjusted by the pitch and the circumference. Single-thread or multi-thread ball screws are conceivable. In comparison to otherwise common trapezoidal spindles, higher efficiencies can also be achieved when converting a rotational movement into a linear movement. The efficiency of the spindle drive is here over 50%.

According to an advantageous aspect, the log splitter further comprises at least one engagement for transporting the log splitter. As a result, the log splitter can be transported to the stem wood and the heavy wooden stems do not have to be transported to the log splitter, which improves the overall handling of the log splitter.

It is advantageous if the drive comprises the energy storage unit, a control unit for controlling the drive and a motor for driving a gearbox. In this way, the log splitter can be controlled in a targeted manner and used in a particularly energy-efficient manner.

It has proven to be advantageous if the drive is a battery-operated hand tool, in particular a battery-operated drill, or a battery-operated screwing tool. By separating the drive unit from the splitting unit, the weight can be reduced, which simplifies transportation, particularly for mobile applications of the log splitter, and enables a high degree of flexibility when operating the log splitter.

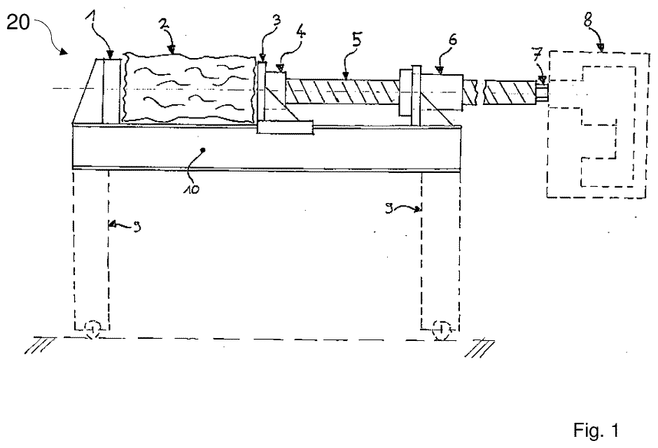

FIG. 1 shows a schematic representation of a log splitter 20 according to the invention for mobile applications. The log splitter comprises a coupling 7 for connection to a drive 8, a receiving unit 10 for a piece of wood 2 to be split, at least one splitting wedge 1 arranged perpendicularly to the receiving unit 10, a stop surface 3 arranged opposite the splitting wedge 1 and a spindle 5 with a receiving element 6 which can be moved along the spindle 5 by means of the drive 8. The coefficient of friction μ between the spindle 5 and the receiving element 6 is 0.001 to 0.048. The receiving unit 10 can be mounted horizontally on at least one rollable support means 9. Furthermore, the log splitter 20 comprises a pressure element 4 for uniform force transmission from the receiving element 6 to the stop surface 3. It is conceivable that the spindle 5 is a planetary roller screw drive (planetary screw drive spindle) or a spindle drive with a friction-optimized polymer nut. However, the spindle 5 is particularly preferably a ball screw. The coefficient of friction μ between a ball screw and the receiving element 6 in this embodiment is between 0.001 and 0.018.

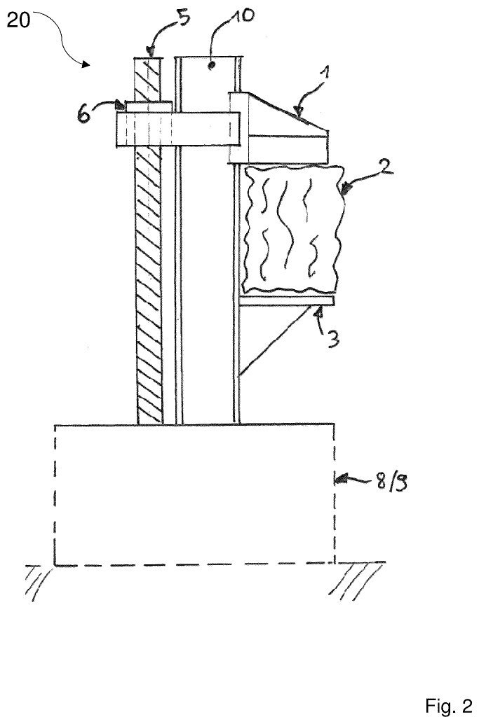

FIG. 2 shows a schematic representation of a log splitter 20 according to the invention, in which the receiving unit 10 and the spindle 5 are arranged parallel to each other on the support means 9. It is conceivable that the drive 8 is integrated into the support means 9. The parallel arrangement of the spindle 5 to the receiving unit 10 enables a very compact design of the log splitter, so that it can be stored and transported in a space-saving manner. In this embodiment, the receiving element 6 can be moved along the spindle 5.

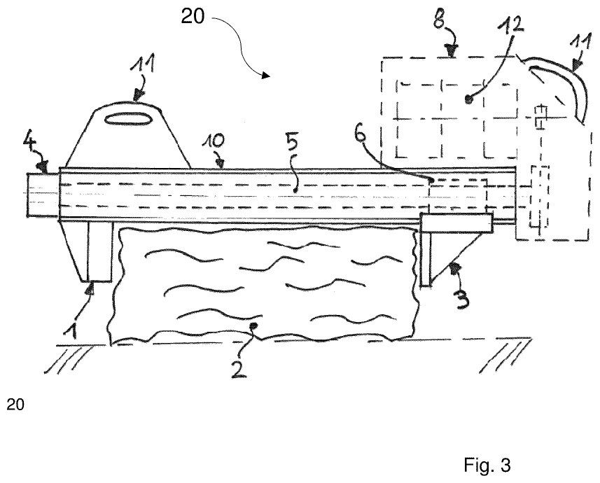

FIG. 3 shows a schematic representation of a log splitter 20 according to the invention, further comprising an energy storage unit 12 for storing and providing energy for the drive 8. The energy storage unit 12 is integrated into the drive 8. It is also conceivable that the energy storage unit 12 is designed as an exchangeable battery system. Overall, this is a battery-powered log splitter. The log splitter 20 also comprises at least one engagement 11 for transporting the log splitter 20.

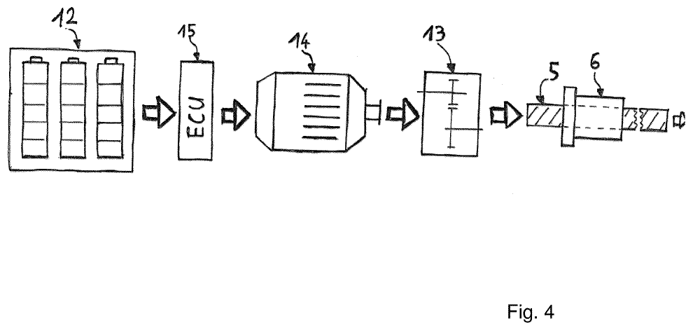

FIG. 4 shows a schematic view of a drive unit 8 for a log splitter 20 according to the invention. The drive 8 comprises the energy storage unit 12, a control unit 15 for controlling the drive 8 and a motor 14 for driving a gearbox 13. For example, the drive 8 can also be a battery-operated drilling machine or a battery-operated impact driver or a battery-operated screwdriver or another drilling or screwing tool, which are operated with electricity or compressed air, for example.

What is claimed is:

1. Log splitter for mobile applications, comprising a coupling for connection to a drive, a receiving unit for a piece of wood to be split, at least one splitting wedge arranged perpendicularly to the receiving unit, a stop surface arranged opposite the splitting wedge, a spindle and a thread receptacle, wherein the spindle can be moved along the thread receptacle or the thread receptacle can be moved along the spindle by means of a drive, wherein the coefficient of friction μ between the spindle and the thread receptacle is 0.001 to 0.048.

2. Log splitter according to claim 1, wherein the receiving unit is mounted horizontally on at least one rollable support means.

3. Log splitter according to claim 1, further comprising an energy storage unit for storing and providing energy for the drive, wherein the energy storage unit is integrated into the drive or is designed to be exchangeable (exchangeable battery).

4. Log splitter according to claim 1, wherein the drive is integrated into the support means.

5. Log splitter according to claim 1, wherein the spindle is a planetary roller screw drive or a spindle drive with a friction-optimized polymer nut.

6. Log splitter according to claim 1, wherein the spindle is a ball screw, wherein the coefficient of friction μ between the ball screw and the thread receptacle is 0.001 to 0.018.

7. Log splitter according to claim 1, further comprising at least one engagement for transporting the log splitter.

8. Log splitter according to claim 1, further comprising a pressure element for uniform force transmission from the thread receptacle to the stop surface.

9. Log splitter according to claim 1, wherein the drive comprises the energy storage unit, a control unit for controlling the drive and a motor for driving a gearbox.

10. Log splitter according to claim 1, wherein the drive is a battery-powered hand tool.
